(19) United States
(12) Patent Application Publication
(10) Pub. No.: US 2015/0355870 A1
(43) Pub. Date: Dec. 10, 2015

(54) MESSAGE OUTPUT BASED ON VALUE

(71) Applicant: Hewlett-Packard Development Company, L.P., Houston, TX (US)

(72) Inventors: Rowdy K. Webb, Portland, OR (US); Jefferson P. Ward, Brush Prairie, WA (US); Corlene Ankrum, Vancouver, WA (US)

(73) Assignee: HEWLETT-PACKARD DEVELOPMENT COMPANY, L.P., Houston, TX (US)

(21) Appl. No.: 14/762,170

(22) PCT Filed: Feb. 25, 2013
(86) PCT No.: PCT/US2013/027647

§ 371 Date: Jul. 20, 2015

(51) Int. Cl. G06F 3/12

(52) U.S. Cl. CPC G06F 3/1229; G06F 3/1219

(57) ABSTRACT

A first, message is output the resource balance is less than or equal to the low value or the device total is greater than or equal to the very low value. A second message is output if the resource balance is less than or equal to the very low value or the device total is greater than or equal to the very low value. Use of the device or resource is stopped until a user acknowledges the second message.

### BACKGROUND

User devices may subscribe to a service over a network from a provider. The service may allow the device to use a resource locally according to a subscription plan. Providers are challenged to provide their services in a reliable and uninterrupted manner to the user device over the network while maintaining security and ease of use.

### BRIEF DESCRIPTION OF THE DRAWINGS

The following detailed description references the drawings, wherein:

FIG. 1 is an example block diagram of a device for outputting a message based on a value;

FIG. 2 is another example block diagram of a device for outputting a message based on a value;

FIG. 3 is an example block diagram of a computing device including instructions for outputting a message based on a value; and

FIG. 4 is an example flowchart of a method for outputting a message based on a value.

### DETAILED DESCRIPTION

Specific details are given in the following description to provide a thorough understanding of embodiments. However, it will be understood that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Subscription to services over a network by user devices is becoming more prevalent with advances in technology. Such subscriptions may provide credits having a quantifiable value to the user device over the network in exchange for a periodic fee, such as a monthly fee. In turn, the user device may use the credits to buy and/or consume a local resource. For example, a provider may provide a printing service to a user device, such as a printer, where each credit may allow the printer to print a specified number of pages, such as 500 pages per credit. In this scenario, ink for the printer may be included in the subscription fee. For example, the provider may monitor ink levels at the printer and send new ink cartridges when ink levels become low, such as every 3 to 24 months. In one instance, the subscription may allow the user to print a fixed number of pages per month.

However, if the user device begins to run low on credits, there may be a risk of the user running out of credits, and thus being unable to use the resource, such as being unable to print. Reasons for running low on credits may include, for example, a connection issue where the user device is unable to establish a connection with the provider or a subscription issue where the provider stops sending credits due to an issue with the user's subscription plan. If the user is not aware that the credits are running low, determining how to receive additional credits after the credits have already been depleted may become a time consuming affair for the user that could lead to user dissatisfaction and/or ultimately cancellation or non-renewal of the subscription, even if the provider is not at fault. Moreover, use of the resource may be time-sensitive. For example, the user may need to print a document immediately or very soon. In this case, the user may not have time to determine how to receive additional credit or suffer high losses while determining how to receive additional credit.

On the other hand, the provider may not desire to provide credits unconditionally or provide too many credits within at a given time, for security or financial reasons. For example, the provider may wish to stop the user from using the resource if the user has obtained access to the credit or resource through fraudulent means, such as without paying for the subscription plan or tampering with a counter of the resource.

Embodiments notify the user that the user is low on credits or that the resource limit is being reached, before the credits are depleted or the resource limit is reached. The term credit may be used interchangeably with packet and/or subscription total. For example, in one embodiment, a device may include a receiving unit, a determination unit and a message unit. The receiving unit may receive a packet from a provider including a low value and a very low value. The determination unit may compare a resource balance to the low value and/or the very low value. The resource balance may indicate an amount of a resource available to the device. The message unit may output a first message to a user interface of the device based on the comparison. The message unit may output the first message to the user interface if the resource balance is less than or equal to the low value. The message unit may prevent the device from continuing to use the resource until a user of the device acknowledges the first message and/or a second message output to the user interface by the message unit, if the resource balance is less than or equal to the very low value.

Thus, embodiments allow the user to resolve a low resource balance before the resource balance becomes depleted. Further, embodiments may provide the user with guidance as to a cause and/or solution to the low resource balance. In addition, embodiments may allow the provider to dynamically and/or flexibly determine when and/or how the first and/or second message is displayed based on at least values for the low value and the very low value. As a result, the provider may be able improve an adoption rate of its subscription and customer satisfaction and retention rate may be improved.

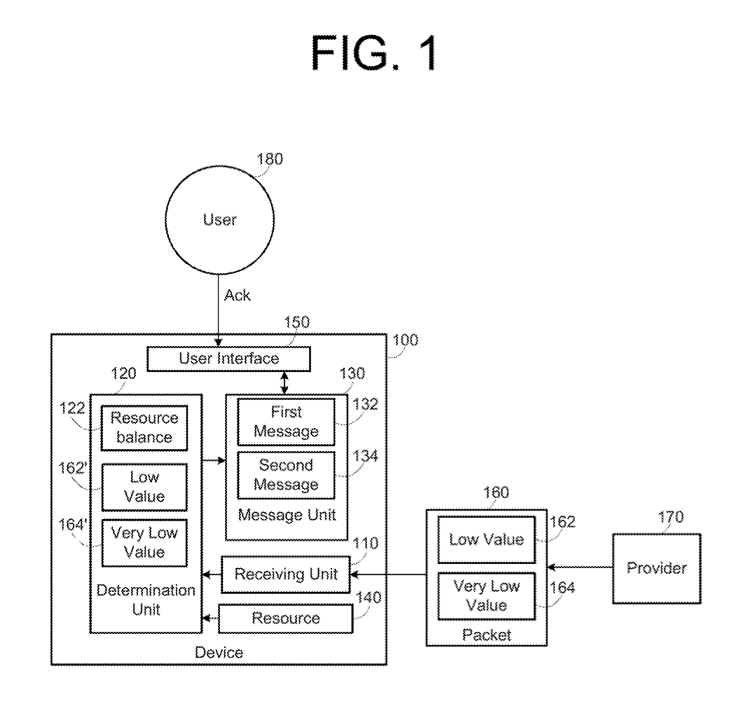

Referring now to the drawings, FIG. 1 is an example block diagram of a device 100 for outputting a message based on a value. The device 100 may be any type of device capable of receiving a packet 160 over a network connection, such as a printer, fax machine, mobile device, computer, and the like. For example, the device 100 may include a memory (not shown) for storing data, the packet 160 and/or instructions and a processor (not shown) to execute instructions. The packet 160 may be any type of message sent over a network (not shown) by a provider 170 to the device 100.

The provider 170 may be any type of entity that provides a service, such as an application service provider (ASP), a network service provider (NSP), an internet service provider (ISP), a managed service provider (MSP), a storage service provider (SSP), a manufacturer of the subscription device 110, a telecommunications service provider (TSP), and the like. The term network may refer to any type of system capable of establishing a communication channel between two remote devices and/or entities, such as the device 100 and the provider 170. Examples of a type of the network may include a personal area network (PAN), a local area network (LAN), a home network, a storage area network (SAN), a campus network, a backbone network, a Metropolitan area network (MAN), a wide area network (WAN), an enterprise private network, a virtual private network (VPN), an Internetwork, and the like.

As explained above, the provider 170 may provide a subscription for a resource 140, with the packet 160 including an amount of the resource accumulated at a given time. Even though a single packet 160 is shown in FIG. 1, the provider 170 may provide a plurality of packets 160 over at different intervals of times, such as one packet 160 per day. The resource 140 may relate to any type of service and/or product being used by the device 100, such pages of paper, volume of ink, amount of time the device 100 may be on, a number of accesses allowed by the device 100 to content or a service, and the like. For instance, if the subscription relates to a monthly subscription for printing, the provider 170 may send the packet 160 every day to the device 100 indicating a total amount of pages available to the device 100 at the time the packet 160 is sent. For example, a first packet 160 may indicate 50 pages and a next packet may indicate 100 pages, and so on. The number of pages may continue to increase month-to-month, without resetting.

The device 100 is shown to include a receiving unit 110, a determination unit 120, a message unit 130, a resource 140 and a user interface 150. The determination unit 120 and the message unit 130 may include, for example, a hardware device including electronic circuitry for implementing the functionality described below, such as control logic and/or memory. In addition or as an alternative, the determination unit 120 and the message unit 130 may be implemented as a series of instructions encoded on a machine-readable storage medium and executable by a processor. The receiving unit 110 may include any type of hardware and/or protocols for interfacing with the network to receive the packet 160, such as network interface card (NIC). The user interface 150 may include any type of hardware and/or software for interfacing with a user 180, such as a touch interface, a keyboard, a mouse, hard buttons, soft buttons and the like.

The receiving unit 110 may receive the packet 160 from the provider 170 including a low value 162 and a very low value 164. The determination unit 120 may compare a resource balance 122 to the low value 162 and/or the very low value 164. The determination unit 120 may also store the low value 162′ and/or the very low value 164′. The resource balance 122 may indicate an amount of the resource 140 available to the device 100. The resource 140 may relate to, for example, pages, ink, time and accesses. While the resource 140 is shown to be internal to the device 100, embodiments of the device 100 may also have the resource 140 being external to the device 100.

The message unit 130 may output a first message 132 and/or a second message 134 to the user interface 150 based on the comparison by the determination unit 120. For instance, the message unit 130 may output the first message 132 to the user interface 150 if the resource balance 122 is less than or equal to the low value 162′. The message unit 130 may output the second message 134 to the user interface 150 if the resource balance 122 is less than or equal to the low value 164′. Further, the message unit 130 may stop the device 100 from using the resource 140 until the user 180 acknowledges the first message 132 and/or second message 134 output to the user interface 150 by the message unit 130, if the resource balance 122 is less than or equal to the very low value 164′. The user 180 may acknowledge the first and/or second messages 132 and 134 by, for example, touching a soft or hard or button, tapping a touch-sensitive display, and the like of the user interface 150.

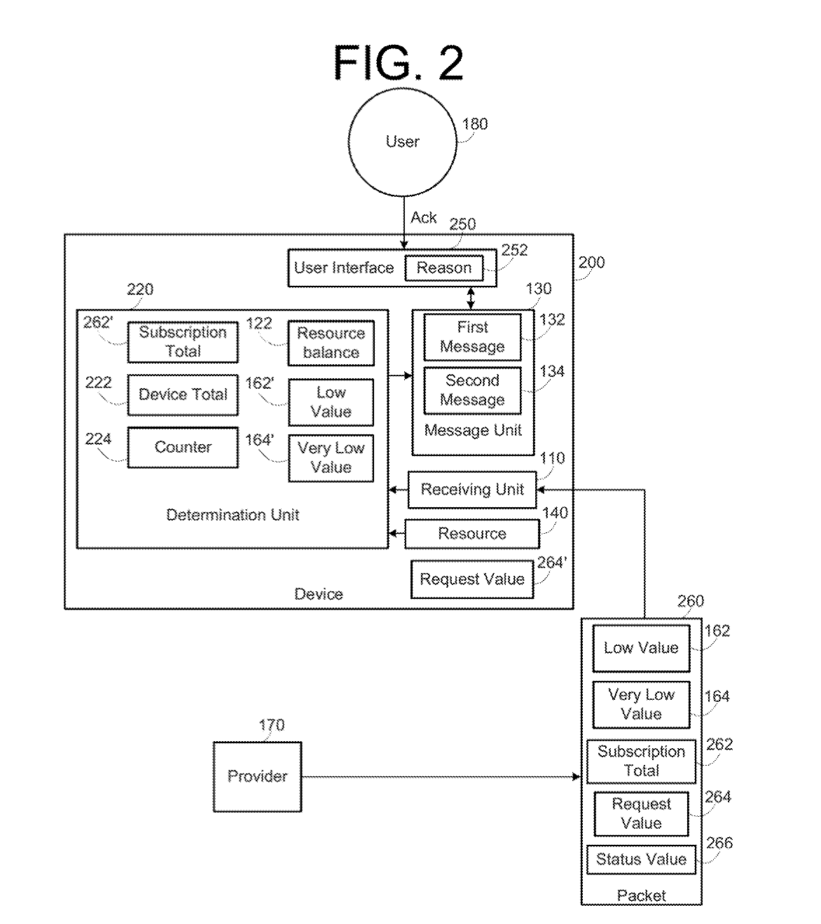

A content of the second message 134 may provide a more urgent warning to the user 180 than a content of the first message 132. For example, the content of the first message 132 may indicate to the user 180 that the resource balance 122 is low. The content of the second message 134 may indicate that the resource balance 122 is nearing depletion and that the device 100 will stop using the resource 140 if the resource balance 122 reaches zero. The outputting of the first and second messages 132 and 134 will be explained in greater detail below with respect to FIG. 2.

While FIG. 1 describes the first and second messages 132 and 134 being output if the resource balance 122 is less than or equal to the low value 162′ and/or very low value 164′; embodiments may also output the first and second messages 132 and 134 if the low value 162′ and/or very low value 164′ are greater than or equal to another value, such as a device total (not shown), as explained below in FIGS. 2 to 4.

FIG. 2 is another example block diagram of a device 200 for outputting a message based on a value. The device 200 is shown to include the receiving unit 110, a determination unit 220, the message unit 130, the resource 140 and a user interface 250. The device 200 of FIG. 2 may include at least the functionality and/or hardware of the device 100 of FIG. 1. For instance, the receiving unit 110, the determination unit 220, the message unit 130, the resource 140 and the user interface 250 included in the device 200 of FIG. 2 may respectively include the functionality of the receiving unit 110, a determination unit 120, the message unit 130, the resource 140 and a user interface 150 included in the device 100 of FIG. 1. Further, the device 200 of FIG. 2 also stores a device total 222, a subscription total 262′ and a request value 264′ and includes a counter 224, as will be explained in further detail below.

In FIG. 2, the device 200 and the provider 170 may interact similarly to the subscription device 100 and the provider 170 of FIG. 1. In addition to the functionality described in FIG. 1, the determination unit 220 may also calculate a difference between the subscription total 262′ and the device total 222 to determine the resource balance 122. The subscription total 262 may be included in the packet 260 received by the receiving unit 110 and then stored in the device 200. The subscription total 262 may indicate an amount of the resource 140 accumulated by the device 200 at a time the packet 260 is transmitted by the provider 170. The device total 222 may to indicate the amount of the resource 140 consumed by the device 200.

While FIG. 2 only shows a single packet 260, the receiving unit 110 may receive a plurality of packets 260 from the provider 170 over a life of the subscription. Further, the provider 170 may change the low value 162 and/or the very low value 164 dynamically throughout the plurality of packets 260 based on various factors. In addition, the subscription total 262 may increase over a life of the subscription. For example, the subscription total 262 may be 100 for an initial packet 260, 200 for a subsequent packet 260, and so on.

The counter 224 is to add the amount of the resource 140 used by the device 200 at a given time to the device total 222. The counter 224 may be any type of device which stores a number of times a particular event or process has occurred. The counter 224 may only count upward and the counter 224 may be encrypted and/or a secure device that is designed to be tamperproof. Thus, the device total 214 may not be resettable by the user 120 and a likelihood of the device total 214 being fraudulently lowered may be reduced. Further, the packet 260 may include a digital signature to ensure its authenticity and/or be encrypted via an asymmetric key algorithm or hardware security module (HSM)-backed key pair.

For example, assuming the resource 140 being counted is pages printed, the device total 222 may be 500 if the user 120 has printed 500 pages thus far over the life of the subscription. If the user 120 then prints 50 more pages, the counter 224 may add 50 to the device total 222 such that the device total 214 is now 550.

In one embodiment, the counter 224 may count the resource 140 before it is consumed by the device 200, such as by counting all the pages to be used or a spooled document. In another embodiment, the counter 224 may count the resource 140 after it is consumed by the device 210, such as by individually counting every page of a document after it is printed. While the counter 224 is shown within the determination unit 220 the counter 224 may also be separate from the determination unit 220.

However, if the device 200 stops receiving the packets 260 or a subsequent packet 260 does not arrive soon enough, the subscription total 262 may remain the same while the device total 222 steadily increases, causing the resource balance 122 to increasingly diminish as the device total 222 approaches the subscription total 262′. In one embodiment, the packet 260 may also includes a request value 264 and the device 200 may request an increase in the subscription total 262 from the provider 170 if the request value 264′ is less than or equal to the resource balance 122. For example, the request value 264 may be 30, the low value 162 may be 20, and the very low value 164 may be 10. In this case, if the resource balance 122 reaches 30, the device 200 may send a message to the provider 170 requesting another packet 160 in order to increase the subscription total 262 and therefore increase the resource balance 122.

As a result, the provider 170 may send a next packet 260 to the device 200 sooner than planned and/or determine that previously sent packets 260 are not being received by the device 200. For example, the provider 170 may send the next packet 260 within 5 minutes instead of the next day. As seen here, the request value 264 is generally larger than the low and very low values 162 and 164. Thus, if the resource balance 122 reaches the request value 264 and the resource balance 122 is subsequently increased, the device 200 may be able to avoid or reduce a likelihood of the resource balance 122 reaching the low and very low values 162 and 164.

The packet 260 further includes a status value 266 indicating a reason 252 that is to be displayed at the user interface 250. The reason 252 may provide a cause for the resource balance 122 being less than or equal to the low value 162 and/for the very low value 164. The reason 252 is to further provide a path for resolving the cause. The cause may be, for example, a subscription issue or a connection issue. The subscription issue may relate to a subscription account of the user 180, such as the subscription having expired or the provider 170 being unable to charge a credit card of the user 180. The connection issue may relate to the provider 170 being able to establish a connection with the device 200.

The path may provide, for example, a phone number, an internet link, an email, a text and the like, if the cause is the subscription issue. On the other hand, the path may provide trouble shooting it the cause is the connection issue. The device 200 may determine itself that the cause is the connection issue if the status value 266 does not indicate the subscription issue. For example, if the device 200 is unable to resolve and/or receive the status value 266, the device 200 may have a default setting for the cause to be the connection issue.

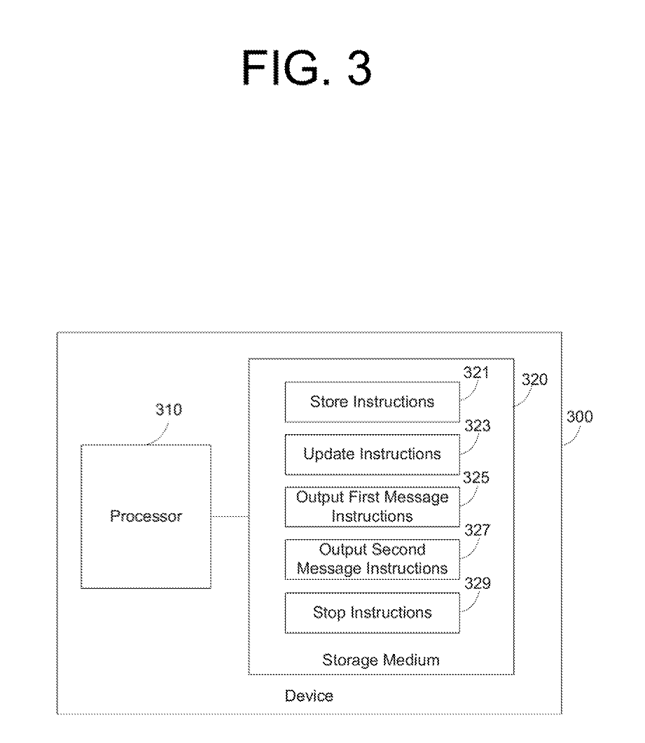

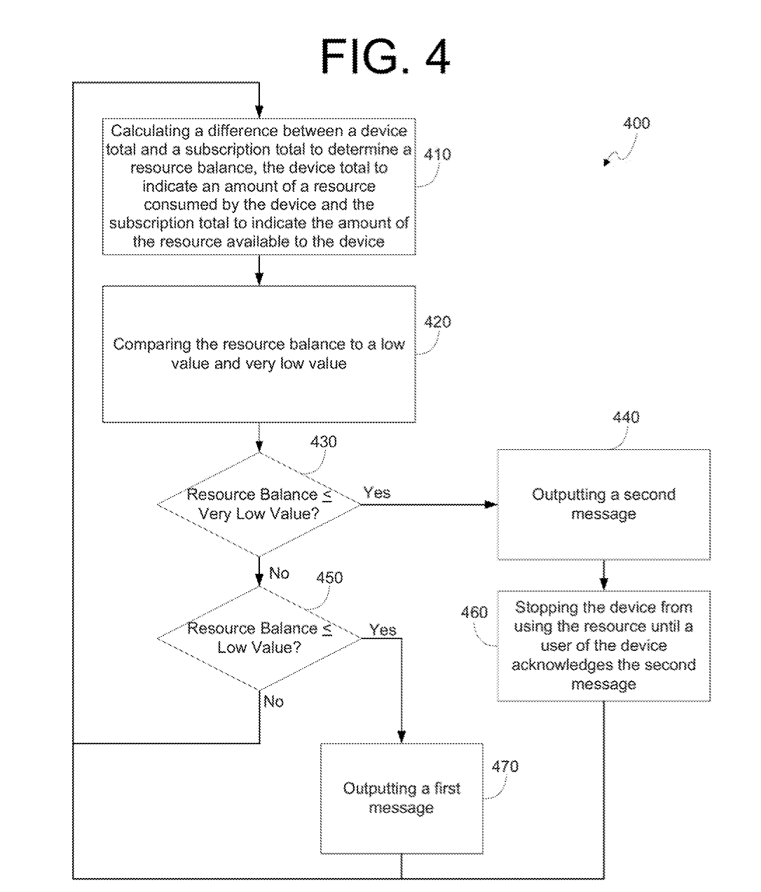

As explained above in FIG. 1 and further explained below in FIGS. 3 to 4, the low value 162′ and/or very low value 164′ may be compared to the device total 222 instead of the resource balance 122. In this case, the device 200 may output the first and second messages 132 and 134 if the low value 162′ and/or very low value 164′ are less than or equal to the device total 222. Here, the provider 170, instead of the device 200, may perform a subtraction operation before sending the packet 260, to determine the low value 162 and/or very low value 164. For example, the provider 170 may set the low value 162′ and/or very low value 164′ to be a certain number below and/or percentage of the subscription total 262. For instance, if the subscription total 262 is 100, the provider 170 may set the the low value 162′ to be 80% of the subscription total 262 or 80 and the very low value 164′ to be 90% of the subscription total 262 or 90. Then, if the device total 222 reaches 80, the device 200 may output the first message 132. Similarly, if the device total 222 reaches 90, the device 200 may output the second message 134 as well as stop the user 180 from using the resource 140 until the user 180 acknowledges the second message 134.

FIG. 3 is an example block diagram of a computing device 300 including instructions for outputting a message based on a value. In the embodiment of FIG. 3, the computing device 300 includes a processor 310 and a machine-readable storage medium 320. The machine-readable storage medium 320 further includes instructions 321, 323, 325, 327 and 329 for outputting a message based on a value.

The computing device 300 may be, for example, a printer, a mobile device, a fax machine, multimedia device, a secure microprocessor, a notebook computer, a desktop computer, an all-in-one system, a server, a network device, a controller, a wireless device, or any other type of device capable of executing the instructions 321, 323, 325, 327 and 329. In certain examples, the computing device 300 may include or be connected to additional components such as memories, controllers, etc.

The processor 310 may be, at east one central processing unit (CPU), at least one semiconductor-based microprocessor, at least one graphics processing unit (GPU), a microcontroller, special purpose logic hardware controlled by microcode or other hardware devices suitable for retrieval and execution of instructions stored in the machine-readable storage medium 320, or combinations thereof. The processor 310 may fetch, decode, and execute instructions 321, 323, 325, 327 and 329 to implement outputting the message based on the value. As an alternative or in addition to retrieving and executing instructions, the processor 310 may include at least one integrated circuit (IC), other control logic, other electronic circuits, or combinations thereof that include a number of electronic components for performing the functionality of instructions 321, 323, 325, 327 and 329.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for outputting the message based on the value.

Moreover, the instructions 321, 323, 325, 327 and 329 when executed by a processor (e.g., via one processing element or multiple processing elements of the processor) can cause the processor to perform processes, such as, the process of FIG. 4. For example, the store instructions 321 may be executed by the processor 310 to store a low value and very low value received from a packet (not shown) sent over a network by a provider (not shown). The update instructions 323 may be executed by the processor 310 to update a device total (not shown) when a device consumes a resource (not shown). The device total may indicate a total amount of the resource consumed by the device.

The output first message instructions 325 may be executed by the processor 310 to output a first message to a user of the device if the device total is greater than or equal to the low value. The output second message instructions 327 may be executed by the processor 310 to output a second message to the user if the device total is greater than or equal to the very low value. The low and very low values may indicate amounts at which the device total is near an amount of the resource allowed to the device by the provider. For example, the provider may allow only 100 units of the resource at a given time and therefore, at the given time, set the low value to be 80 and the very low value to be 90. Thus, if the device total reaches 80, the device 300 may output the first message and if the device total reaches 90, the device 300 may output the second message,

Conversely, the device 300 may calculate a difference between a subscription total (not shown) and the device total to determine a resource balance (not shown). The subscription total may indicate the amount of the resource allowed by the provider. The device 300 may then compare the low and very low values to the resource balance, instead of the device total. Here, the low and very low values may indicate amounts at which the resource balance is nearing depletion. In this case, the output first message instructions 325 may be executed by the processor 310 to output the first message to the user of the device if the resource balance is less than or equal to the low value.

Similarly, the output second message instructions 327 may be executed by the processor 310 to output the second message to the user if the resource balance is less than or equal to the very low value. For example, at the given time, the subscription total may be 100, the low value may be 20 and the very low value may be 10. Thus, if the device total reaches 80, the resource balance would reach 20, causing the first message to be output. Further, if the device total reaches 90, the resource balance would reach 10, causing the second message to be output.

The stop instructions 329 may be executed by the processor 310 to stop a user from using the device until the user acknowledges the second message, if the second message is outputted. The first and/or second messages may provide a cause for and/or solution to the device total nearing the amount of the resource allowed and/or the resource balance reaching depletion. For example, the first and/or second messages may indicate an issue with the user's subscription and provide a telephone number for contacting the provider.

FIG. 4 is an example flowchart of a method 400 for outputting a message based on a value. Although execution of the method 400 is described below with reference to the device 200, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the device 200 calculates a difference between a device total 222 and a subscription total 262′ to determine a resource balance 122. The device total 222 may indicate an amount of a resource 140 consumed by the device 200 and the subscription total 262′ may indicate the amount of the resource 140 available to the device 200. Then, at block 420, the device 200 compares the resource balance 122 to a low value 162′ and very low value 164′ and flows to block 430.

If the resource balance 122 is less than or equal to the very low value 164, the method 400 flows to block 440, where the device 200 outputs a second message 134. Next, at block 460, the device 200 stops a user 180 of the device 200 from using the resource 140 until the user 180 acknowledges the second message 134. Afterward, the method 400 returns to block 410.

However, if the resource balance 122 is greater than the very low value 164′, the method 400 flows to block 450. At block 450, if the resource balance 122 is less than or equal to the low value 162′, the method 400 flows to block 470 where the device 200 outputs a first message 132. Afterward, the method 400 returns to block 410. On the other hand, at block 450, if the resource balance 122 is also greater than the low value 162′, then the method 400 directly returns to block 410.

A provider 170 may transmit a packet 260 over a network to the device 200 that includes the low value 162, the very low value 164, and the subscription total 262. The very low value 164 is generally smaller than the low value 162. The device 200 may only increase the device total 222 over a life of a subscription to the resource 140 and/or a life of the device 200.

In the above embodiment, the low and very low values 162 and 164 may indicate amounts at which the resource balance 122 is nearing depletion. However, as explained in FIGS. 1-3, embodiments of the low and very low values 162 and 164 may instead indicate amounts at which the device total 222 is near an amount of the resource 140 allowed to the device 200 by the provider 170. Here, the very low value 164 may be greater than the low value 162.

In this case, block 410 may be removed from the method 400. Further, at block 420, the device total 222 (instead of the resource balance 122) may be compared to the low and very low values 162′ and 164′. Also, at blocks 430 and 450, the method 400 may respectively determine if the device total 222 (instead of the resource balance 122) is less than (instead of greater than) or equal to the very low value 164′ and the low value 162′.

According to the foregoing, embodiments provide a method and/or device for notifying the user that the user is low on credits or that the resource limit is being reached, before the credits are depleted or the resource limit is reached. Further, embodiments may provide the user with guidance as to a cause for and/or solution to the low resource balance. In addition, embodiments may allow the provider to dynamically and flexibly determine when and/or how the first and/or second message is displayed based on at least values for the low value and the very low value.

We claim:

1. A device, comprising:
a receiving unit to receive a packet from a provider including a low value and a very low value; and
a determination unit to compare a resource balance to at least one of the low value and the very low value, the resource balance to indicate an amount of a resource available to the device; and
a message unit to output a first message to a user interface of the device based on the comparison, wherein
the message unit is to output the first message to the user interface if the resource balance is less than or equal to the low value, and
the message unit is to stop the device from using the resource until a user of the device acknowledges at least one of the first message and a second message output to the user interface by the message unit, if the resource balance less than or equal to the very low value.

2. The device of claim 1, wherein,
the message unit is to output the second message if the resource balance is less than or equal to the very low value, and
a content of the second message is to provide a more urgent warning to the user than a content of the first message.

3. The device of claim 2, wherein,
the content of the first message is to indicate to the user that the resource balance is low, and
the content of the second message is to indicate that the resource balance is nearing depletion and that the device will stop using the resource if the resource balance reaches zero.

4. The device of claim 1, wherein,
the determination unit is to calculate a difference between a subscription total and a device total to determine the resource balance,
the subscription total is included in the packet received by the receiving unit and is to indicate an amount of the resource accumulated by the device at a time the packet is transmitted by the provider, and
the device total is to indicate the amount of the resource consumed by the device.

5. The device of claim 4, wherein,
the device includes a counter to add the amount of the resource used by the device to the device total,
the counter is to only count upward, and
the counter is at least one of encrypted and a secure device.

6. The device of claim 4, wherein,
the packet further includes a request value, and
the device is to request an increase in the subscription total from the provider if the request value is less than or equal to the resource balance.

7. The device of claim 4, wherein,
the receiving unit is to receive a plurality of the packets, and
at least one of the low value and the very low value is to change dynamically throughout the plurality of packets.

8. The device of claim 1, wherein,
the packet further includes a status value indicating a reason to be displayed at the user interface, and
the reason is to provide a cause for the resource balance being less than or equal to at least one of the low value and the very low value.

9. The device of claim 8, wherein,
the reason is to further provide a path for resolving the cause, and
the cause is at least of a subscription issue and a connection issue.

10. The device of claim 9, wherein,
the path is to provide at least one of a phone number, an internet link, an email, and a text, if the cause is the subscription issue,
the path is to provide trouble shooting if the cause is the connection issue, and
the device is to determine the cause to be the connection issue if the status value does not indicate the subscription issue.

11. The device of claim 1, wherein,
the user is to touch a button of the user interface to acknowledge the at least one of the first and second messages, and
the resource relates to at least one of pages, ink, time and accesses.

12. A method, comprising:
calculating, at a device, a difference between a device total and a subscription total to determine a resource balance, the device total to indicate an amount of a resource consumed by the device and the subscription total to indicate the amount of thee resource available to the device;
comparing, at the device, the resource balance to a low value and very low value;
outputting, at the device, a first message if the resource balance is less than or equal to the low value;
outputting, at the device, a second message if the resource balance is less than or equal to the very low value; and
stopping, at the device, the device from using the resource until a user of the device acknowledges the second message, if the resource balance is less than or equal to the very low value.

13. The method of claim 12, wherein,
the very low value is smaller than the low value,
a provider transmits a packet over a network to the device that includes the low value, the very low value, and the subscription total, and
the device is to only increase the device total over a life of at least one of a subscription to the resource and the device.

14. A non-transitory computer-readable storage medium storing instructions that, if executed by a processor of a device, cause the processor to:
store a low value and very low value received from a packet sent over a network by a provider;
update a device total when a device consumes a resource, the device total to indicate a total amount of the resource consumed by the device:
output a first message to a user of the device if the device total is greater than or equal to the low value;
output a second message to the user if the device total is greater than or equal to the very low value; and
stop a user from using the device until the user acknowledges the second message, if the second message is outputted.

15. The non-transitory computer-readable storage medium of claim 14, wherein,
the low and very low values are to indicate amounts at which the device total is near an amount of the resource allowed to the device by the provider, and
at least one of the first and second messages is to provide at least one of a cause for and solution to the device total nearing the amount of the resource allowed.
